(19) United States
(12) Patent Application Publication
(10) Pub. No.: US 2026/0165909 A1
(43) Pub. Date: Jun. 18, 2026

(54) DOUBLE-HEADED STRETCHED MASTURBATION CUP

(71) Applicant: Liang CHEN, Shenzhen (CN)

(72) Inventor: Liang CHEN, Shenzhen (CN)

(21) Appl. No.: 18/986,016

(22) Filed: Dec. 18, 2024

(51) Int. Cl. A61H 19/00

(52) U.S. Cl. CPC A61H 19/32; A61H 2201/1671; A61H 2201/1695; A61H 2201/5012

(57) ABSTRACT

The present invention discloses a double-headed stretched masturbation cup, comprising a support assembly; an outer shell wrapped around an outer side of the support assembly wherein the outer shell adopts a soft rubber material; a transmission assembly movably arranged in the support assembly; a double-headed massage cylinder arranged in the outer shell and integrally formed with the outer shell, wherein the double-headed massage cylinder a hollow cavity with two ends open, the double-headed massage cylinder movably passes through the support assembly and is in transmission connection with the transmission assembly, and the transmission assembly drives the double-headed massage cylinder to make a transverse stretching movement in the support assembly. In the present invention, the outer shell and the double-headed massage cylinder both adopt the soft rubber material and the two are integrally formed, and the transmission assembly drives the double-headed massage cylinder to make the stretching movement.

### TECHNICAL FIELD

The present invention relates to the technical field of adult products, in particular to a double-headed stretched masturbation cup.

### BACKGROUND

With the development of the economy and the progress of society, men are under greater work pressure due to the heavy and busy fast pace, so it has become inevitable and social consensus to relieve daily work pressure. Various electrical appliances are increasingly developing in a direction of having the characteristics such as relieving work pressure, being convenient to use, and being safe and efficient, and masturbation cups, as an important member of people's household electrical appliances, are no exception. At present, an existing telescopic masturbation cup structure is to drive a gear to change direction and rotate through the rotation of a driving motor. The gear is connected to a shaft having a spiral track. The contact of the shaft with the spiral track causes movement along the track, producing an up-and-down telescopic effect. The structure is relatively complex, and the existing masturbation cup is relatively simple in appearance, and cannot meet the growing needs of users; therefore, a double-headed stretched masturbation cup is provided, to be used for solving the above problems.

### SUMMARY

One of the purposes of the present invention is to provide a double-headed stretched masturbation cup, so as to solve the problem that an existing telescopic masturbation cup is complicated in structure.

A double-headed stretched masturbation cup of the present invention can be achieved through the following technical solutions:

A double-headed stretched masturbation cup of the present invention comprises a support assembly; an outer shell wrapped around an outer side of the support assembly, wherein the outer side adopts a soft rubber material; a transmission assembly movably arranged in the support assembly; a double-headed massage cylinder being a hollow cavity with two ends open, wherein the double-headed massage cylinder is arranged in the outer shell and integrally formed with the outer shell, and the double-headed massage cylinder movably passes through the support assembly and is in transmission connection with the transmission assembly, wherein the transmission assembly drives the double-headed massage cylinder to make a transverse stretching movement in the support assembly.

In one of the embodiments, the support assembly comprises a first shell and a second shell which form a hollow cavity in a surrounding manner, and the transmission assembly is movably arranged in the cavity.

In one of the embodiments, a plurality of first fixing columns are arranged on an inner wall of the first shell; a plurality of second fixing columns are arranged on an inner wall of the second shell, and positions of the plurality of second fixing columns respectively correspond to positions of the plurality of first fixing columns.

In one of the embodiments, a plurality of mounting columns are arranged on an inner wall of the first shell, and the transmission assembly and the circuit board are respectively fixedly arranged in the first shell through the corresponding mounting columns.

In one of the embodiments, a plurality of fixing holes are arranged on a side wall of the first shell in a penetrating manner, and the transmission assembly is movably arranged in the support assembly through the plurality of fixing holes.

In one of the embodiments, the transmission assembly comprises a plurality of guide rods, wherein the plurality of guide rods are respectively fixed through the corresponding fixing holes and are arranged in parallel on two opposite sides of the support assembly; a support mechanism, wherein the support mechanism is movably arranged on the plurality of guide rods and is in transmission connection with the double-headed massage cylinder; a driving mechanism fixedly arranged in the support assembly through the corresponding mounting columns; and a swing arm with two ends respectively in transmission connection with the driving mechanism and the support mechanism, wherein the driving mechanism drives, through the swing arm, the support mechanism to move on the plurality of guide rods.

In one of the embodiments, the support mechanism includes a first support frame and a second support frame which form a hollow cavity in a surrounding manner; a transmission head is arranged on the first support frame, and one end of the swing arm is in transmission connection with the transmission head.

In one of the embodiments, the driving mechanism comprises a fixing cavity fixedly arranged in the support assembly through the corresponding mounting columns; a driving motor arranged in the fixing cavity and in transmission connection with the swing arm, wherein the driving motor is capable of rotating forward and reversely.

In one of the embodiments, the outer shell adopts a soft rubber material, a first end face and a second end face are respectively arranged on two opposite sides of the outer shell, and shapes of the first end face and the second end face respectively adopt shapes of a female face and a female genitalia.

In one of the embodiments, a second through-hole and a third through-hole are respectively arranged on the first end face and the second end face in a penetrating manner, and the second through-hole and the third through-hole are provided in a manner of respectively communicating with the double-headed massage cylinder.

In one of the embodiments, the double-headed massage cylinder is a cylindrical hollow cavity with two ends open, a first connection end and a second connection end are respectively arranged on two opposite sides of the double-headed massage cylinder, the first connection end is arranged in a manner of communicating with the second through-hole, and the second connection end is arranged in a manner of communicating with the third through-hole.

In one of the embodiments, two ends of the double-headed massage cylinder are arranged in a communicating manner.

In one of the embodiments, the two ends of the massage body are arranged in a manner of not communicating with each other.

In one of the embodiments, a plurality of massage parts are evenly and separately arranged on an inner wall of the double-headed massage cylinder.

In one of the embodiments, the massage parts adopt protruding points, and the protruding points and the double-headed massage cylinder are integrally formed.

In one of the embodiments, a double-headed stretched masturbation cup of the present invention further comprises a circuit board, a battery assembly, a key assembly and a charging assembly; the circuit board and the battery assembly being respectively fixedly arranged in the support assembly, and the circuit board being respectively electrically connected to the transmission assembly, the battery assembly, the key assembly and the charging assembly; the key assembly and the charging assembly being respectively arranged on the circuit board and respectively passing through the support assembly.

In one of the embodiments, a wireless communication module is arranged on the circuit board, and one or more of a Bluetooth wireless communication module, a WiFi wireless communication module, a 4G wireless communication module and a 5G wireless communication module are adopted for the wireless communication module.

In one of the embodiments, a polymer lithium-ion battery is adopted for the battery assembly.

In one of the embodiments, the key assembly comprises a switch key and a function key, the switch key controls opening and closing of a masturbation cup, and the function key performs function setting on the masturbation cup.

In one of the embodiments, the charging assembly adopts one or more of a charging pin, a Type C charging interface, a Micro USB charging interface and a Lightning charging interface.

Compared with the prior art, a double-headed stretched masturbation cup of the present invention has the beneficial effects as follows:
in a double-headed stretched masturbation cup of the present invention, an outer shell and a double-headed massage cylinder both adopt a soft rubber material and the two are integrally formed, and then a transmission assembly drives the double-headed massage cylinder to make a stretching movement, such that the structure of the masturbation cup is relatively simple, and the problem that an existing telescopic masturbation cup is complicated in structure is effectively solved; at the same time, shapes of two end faces of the outer shell adopt shapes of a female face and a female genitalia, improving the user's visual impact to some extent, and also improves the user's experience and satisfaction.

### BRIEF DESCRIPTION OF DRAWINGS

In order to explain the technical solutions in the embodiments of the present invention more clearly, drawings required to be used in the embodiments will be briefly introduced below. It should be understood that, the drawings below merely show some embodiments of the present invention, and therefore should not be deemed as a limitation on the scope. For those of ordinary skill in the art, under the premise of not exerting creative efforts, other relevant drawings can also be obtained according to these drawings.

FIG. 1 is a schematic structural diagram of a double-headed stretched masturbation cup of the present invention;

FIG. 2 is a schematic structural diagram of the double-headed stretched masturbation cup of the present invention shown in FIG. 1 from another perspective;

FIG. 3 is a schematic cross-sectional structural diagram of the double-headed stretched masturbation cup of the present invention shown in FIG. 1;

FIG. 4 is a schematic exploded structural diagram of the double-headed stretched masturbation cup of the present invention shown in FIG. 1, comprising a support assembly, a transmission assembly and a shell assembly;

FIG. 5 is an exploded schematic diagram of the support assembly shown in FIG. 4;

FIG. 6 is a schematic cross-sectional structural diagram of the shell assembly shown in FIG. 4;

FIG. 7 is a schematic structural diagram of the transmission assembly shown in FIG. 4;

FIG. 8 is a schematic cross-sectional structural diagram of the transmission assembly shown in FIG. 7.

Marks in the drawings: 10. masturbation cup; 11. support assembly; 111. first shell; 1111. first fixing column; 1112. mounting column; 1113. fixing hole; 1114. first through-hole; 112. second shell; 1121. second fixing column; 12. outer shell; 121. first end face; 122. second end face; 123. second through-hole; 124. third through-hole; 125. fourth through-hole; 13. transmission assembly; 131. guide rod; 132. support mechanism; 1321. first support frame; 13211. transmission head; 1322. second support frame; 133. driving mechanism; 1331. fixing cavity; 1332. driving motor; 134. swing arm; 14. double-headed massage cylinder; 141. first connection end; 142. second connection end; 143. massage part; 15. circuit board; 16. battery assembly; 17. key assembly; 18. charging assembly; 19. key shell.

### DETAILED DESCRIPTION OF THE EMBODIMENTS

In order to make the purpose, technical solution and advantages of the embodiments of the present invention clearer, the technical solutions in the embodiments of the present invention will be described clearly and completely below in conjunction with the accompanying drawings in the embodiments of the present invention. Obviously, the described embodiments are only a part of embodiments of the present invention, but not all the embodiments. Generally, assemblies of the embodiments of the present invention described and illustrated in the figures herein may be arranged and designed in a variety of different configurations.

Therefore, the following detailed description of the embodiments of the invention provided in the drawings is not intended to limit the scope of the claimed invention, but rather to merely represent selected embodiments of the present invention. On the basis of the embodiments in the present invention, all other embodiments obtained by those of ordinary skill in the art under the premise of not exerting creative efforts should fall within the scope of protection of the present invention.

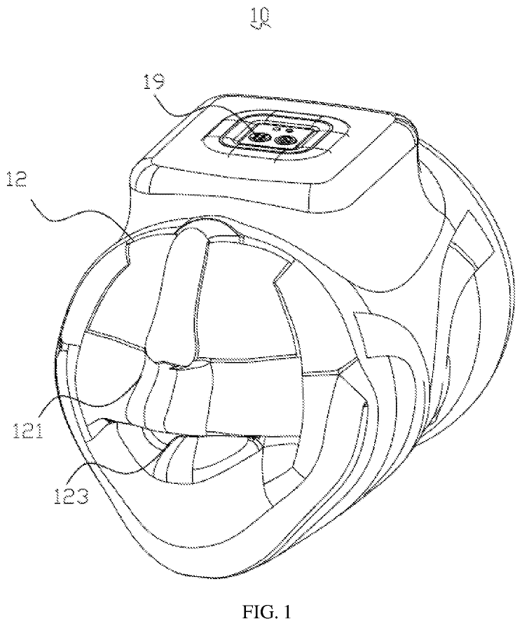

Referring to that shown in FIG. 1 to FIG. 4, a double-headed stretched masturbation cup 10 of the present invention mainly comprises a support assembly 11, an outer shell 12, a transmission assembly 13, a double-headed massage cylinder 14, a circuit board 15, a battery assembly 16, a key assembly 17 and a charging assembly 18; the support assembly 11 is a support body; the outer shell 12 is wrapped around an outer side of the support assembly 11; the transmission assembly 13 is movably arranged in the support assembly 11, and can move transversely in the support assembly 11; the double-headed massage cylinder 14 is a hollow cavity with two ends open, is integrally formed and arranged in the outer shell 12, and movably passes through the support assembly 11 and is in transmission connection with the transmission assembly 13, and the transmission assembly 13 drives the double-headed massage cylinder 14 to make a transverse stretching movement in the support assembly 11; the circuit board 15 and the battery assembly 16 are fixedly arranged in the support assembly 11 respectively, the circuit board 15 is electrically connected to the transmission assembly 13, the battery assembly 16, the key assembly 17 and the charging assembly 18 respectively, and the battery assembly 16 provides electrical energy to the transmission assembly 13 and the circuit board 15 respectively; the key assembly 17 and the charging assembly 18 are respectively arranged on the circuit board 15 and respectively penetrate through the support assembly 11. Opening and closing of the masturbation cup 10 and function setting are controlled by the key assembly 17, and a charging operation is performed on the battery assembly 16 by the charging assembly 18.

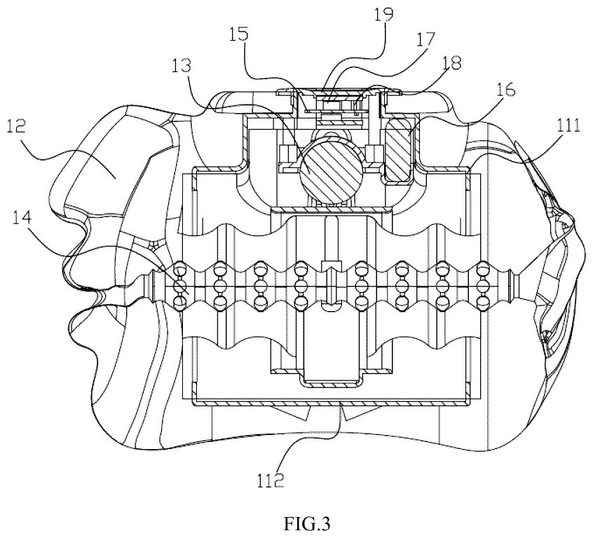

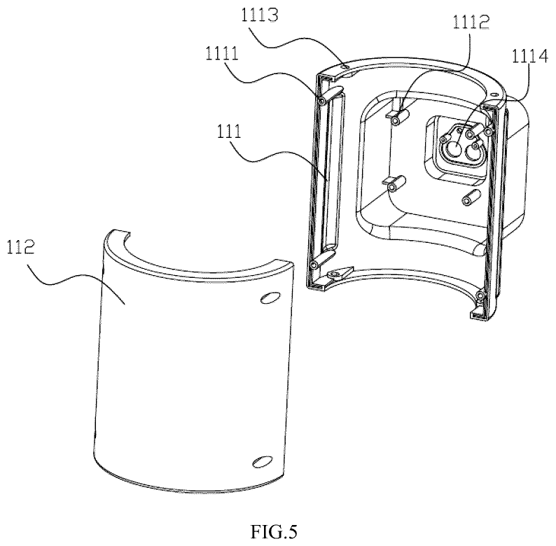

Please refer to that shown in FIG. 3 to FIG. 5. In this embodiment, the support assembly 11 includes a first shell 111 and a second shell 112, the two are combined into a hollow cavity, and the transmission assembly 13 is movably arranged in the cavity. Specifically, a plurality of first fixing columns 1111 and a plurality of mounting columns 1112 are respectively arranged on an inner wall of the first shell 111, and fastening screws are fixedly connected to the second shell 112 through the plurality of first fixing columns 1111, so that the first shell 111 is fixedly arranged on the second shell 112, and the transmission assembly 13 and the circuit board 15 are respectively fixedly arranged in the first shell 111 through the corresponding mounting columns 1112; a plurality of fixing holes 1113 are arranged on a side wall of the first shell 111 in a penetrating manner, and the transmission assembly 13 is movably arranged in the support assembly 11 through the plurality of fixing holes 1113; a plurality of first through-holes 1114 are also arranged on the first shell 111 in a penetrating manner, and the key assembly 17 and the charging assembly 18 respectively penetrate the first shell 111 through the corresponding first through-holes 1114. Specifically, a plurality of second fixing columns 1121 are respectively arranged on an inner wall of the second shell 112, positions of the plurality of second fixing columns 1121 respectively correspond to positions of the plurality of first fixing columns 1111, and fastening screws are tightly connected to the second fixing columns 1121 through the first fixing columns 1111, thereby fixedly arranging the first shell 111 on the second shell 112. Specifically, a key shell 19 is further arranged on the first shell 111, covers the plurality of first through-holes 1114 and is in sealing contact connection with the outer shell 12, thereby enhancing the waterproof performance of the outer shell 12, the key assembly 17 penetrates through the first shell 111 and the key shell 19 in sequence, the charging assembly 18 penetrates through the first shell 111 and is in contact connection with the key shell 19, and a pressing operation can be performed on the key assembly 17 through a corresponding position on the key shell 19.

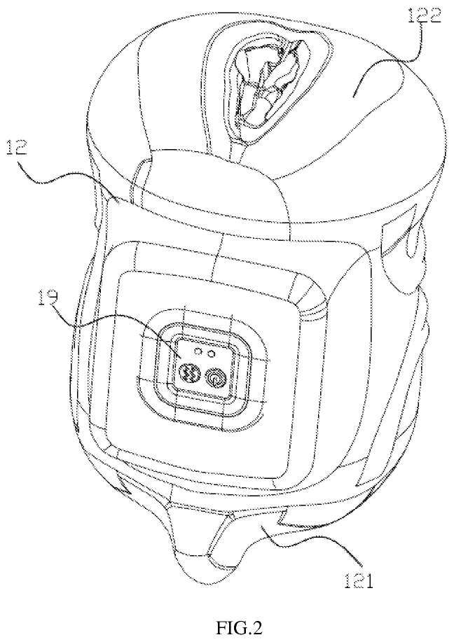

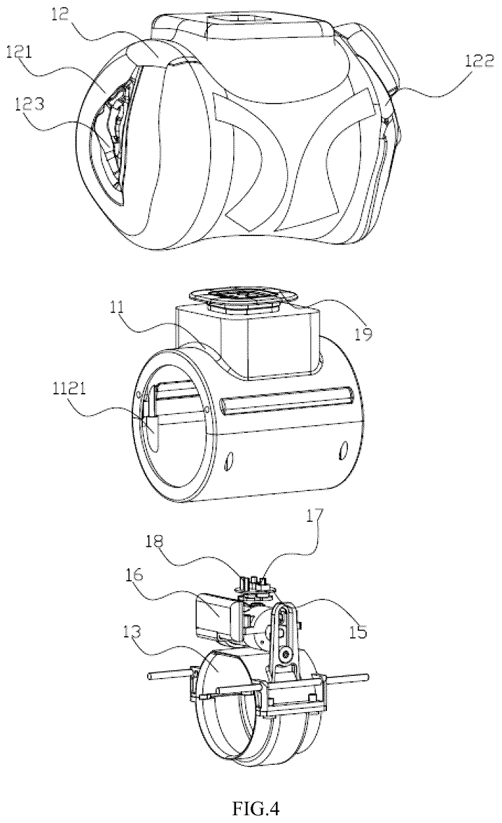

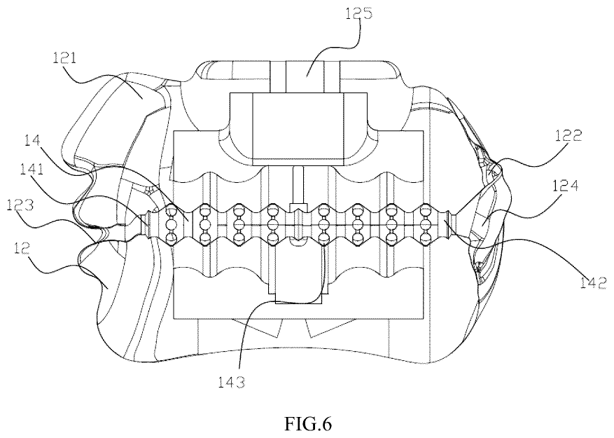

Please refer to that shown in FIG. 1, FIG. 2, FIG. 3, FIG. 4 and FIG. 6. In this embodiment, the outer shell 12 adopts a soft rubber material, a first end face 121 and a second end face 122 are respectively arranged on two opposite sides of the outer shell, and shapes of the first end face and the second end face respectively adopt shapes of a female face and a female genitalia; the first end face 121 and the second end face 122 are respectively provided with a second through-hole 123 and a third through-hole 124 in a penetrating manner, and the second through-hole 123 and the third through-hole 124 are provided in a manner of respectively communicating with the double-headed massage cylinder 14; the outer shell 12 is also provided with a fourth through-hole 125 in a penetrating manner, and the support assembly 11 penetrates the outer shell 12 through the fourth through-hole 125.

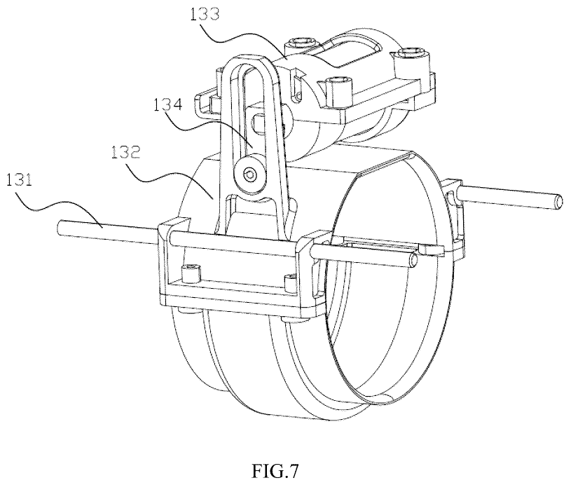

Please refer to that shown in FIG. 3, FIG. 4 and FIG. 7. In this embodiment, the transmission assembly 13 includes a plurality of guide rods 131, a support mechanism 132, a driving mechanism 133 and a swing arm 134; the plurality of guide rods 131 are respectively fixed through the corresponding fixing holes 1113 and are arranged in parallel on two opposite sides of the support assembly 11; the support mechanism 132 is movably arranged on the plurality of guide rods 131 and is in transmission connection with the double-headed massage cylinder 14, and can slide on the guide rods 131, thereby driving the double-headed massage cylinder 14 to perform a stretching operation in the support assembly 11, and the guide rods 131 perform a limiting guide operation on a movement of the support mechanism 132; the driving mechanism 133 is fixedly arranged in the support assembly 11 through the corresponding mounting column 1112; one end of the swing arm 134 is in transmission connection with the driving mechanism 133, the other end of the swing arm is in transmission connection with the support mechanism 132, and the driving mechanism 133 drives, through a transmission action of the swing arm 134, the support mechanism 132 to move on the plurality of guide rods 131, thereby driving the double-headed massage cylinder 14 to perform a stretching operation in the support assembly 11.

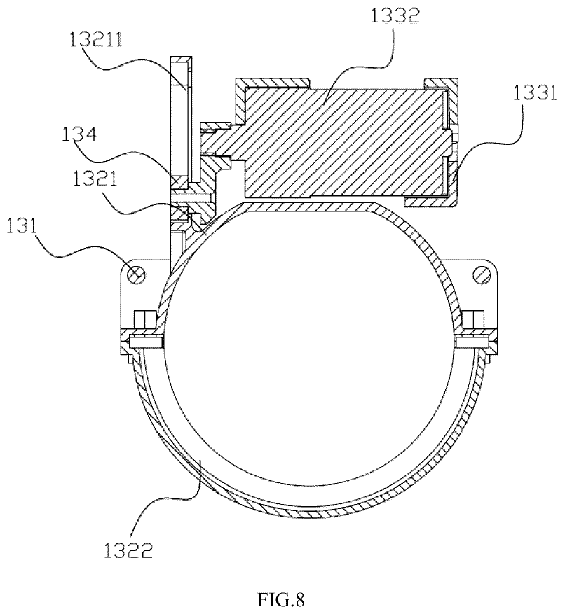

Please refer to that shown in FIG. 7 and FIG. 8. In this embodiment, the support mechanism 132 includes a first support frame 1321 and a second support frame 1322, which are fixedly connected by fastening screws to form a hollow cavity; specifically, a transmission head 13211 is arranged on the first support frame 1321, and one end of the swing arm 134 is in transmission connection with the transmission head 13211, thereby driving the support mechanism 132 to move on the plurality of guide rods 131. Specifically, the driving mechanism 133 comprises a fixing cavity 1331 and a driving motor 1332, and the fixing cavity 1331 is fixedly arranged in the support assembly 11 through the corresponding mounting columns 1112; the driving motor 1332 is arranged in the fixing cavity 1331 and is in transmission connection with the swing arm 134, and can rotate forward and reversely.

Please refer to that shown in FIG. 3 and FIG. 6. Specifically, the double-headed massage cylinder 14 is a cylindrical hollow cavity with two ends open, a first connection end 141 and a second connection end 142 are respectively arranged on two opposite sides of the double-headed massage cylinder, the first connection end 141 is arranged in a manner of communicating with the second through-hole 123, and the second connection end 142 is arranged in a manner of communicating with the third through-hole 124; a plurality of massage parts 141 are evenly and separately arranged on an inner wall of the double-headed massage cylinder 14, and when the transmission assembly 13 drives the double-headed massage cylinder 14 to make a stretching movement, a massage operation is performed, through the plurality of massage parts 141, on a male genital organ in the double-headed massage cylinder 14. In this embodiment, two ends of the double-headed massage cylinder 14 are arranged in a manner of communicating with each other. In other embodiments, two ends of the massage body 141 may also be arranged in a manner of not communicating with each other. The massage parts 141 can adopt protruding points and spiral strips, and both the protruding points and spiral strips are integrally formed with the double-headed massage cylinder 14; in some embodiments, the massage parts 141 can only adopt protruding points, and the protruding points are integrally formed with the double-headed massage cylinder 14; in other embodiments, only spiral strips can be arranged on an inner wall of the massage part 141, and the spiral strips 1412 are integrally formed with the double-headed massage cylinder 14.

Please refer to that shown in FIG. 3 and FIG. 4. In this embodiment, the circuit board 15 is electrically connected to the transmission assembly 13, the battery assembly 16, the key assembly 17 and the charging assembly 18 respectively. Control technologies adopted are all existing technologies, so their specific control process will not be described in detail here, as long as it satisfies the present application; in some embodiments, a wireless communication module can also be arranged on the circuit board 15, and a wireless connection to electronic equipment (such as a mobile phone or tablet computer) is performed through the wireless communication module, and wireless control is performed on the masturbation cup 10 through an application or an applet on the electronic equipment. Specifically, the wireless communication module can adopt one or more of a Bluetooth wireless communication module, a WiFi wireless communication module, a 4G wireless communication module and a 5G wireless communication module. Preferably, the wireless communication module adopts a Bluetooth wireless communication module. In this embodiment, a polymer lithium-ion battery is adopted for the battery assembly 16; the key assembly 17 comprises a switch key and a function key, the switch key controls opening and closing of the masturbation cup 10, and the function key performs function setting on the masturbation cup 10; One or more of a charging pin, a Type C charging interface, a Micro USB charging interface and a Lightning charging interface may be adopted for the charging assembly 18. In this embodiment, the charging pin is adopted for the charging assembly 18.

It should be noted that a specific working process of the double-headed stretched masturbation cup 10 of the present invention is as follows: a user grasps the outer shell 12 with both hands, and then presses the key assembly 17 to select an appropriate massage mode, and the driving motor 1332 drives, through the swing arm 134, the support mechanism 132 to move on the plurality of guide rods 132, thereby driving the double-headed massage cylinder 14 that is in transmission connection with the support mechanism 132 to move in the support assembly 11. By forward and reverse rotation of the driving motor 1332, a stretching operation of the double-headed massage cylinder 14 is synchronously realized.

The technical features of the above-mentioned embodiments can be combined in any way. To simplify the description, not all possible combinations of various technical features in the embodiments are described. However, as long as there is no contradiction in the combinations of these technical features, the combinations should be considered to be within the scope recorded in this specification.

The above-mentioned embodiments only express several implementations of the present invention, and their descriptions are relatively specific and detailed, but they cannot be accordingly construed as limiting the scope of the invention patent. It should be noted that, for those of ordinary skill in the art, several modifications and improvements can be made under the premise of not departing from the concept of the present invention, and these all belong to the protection scope of the present invention. Therefore, the scope of protection of the present invention patent should be subject to the appended claims.

What is claimed is:

1. A double-headed stretched masturbation cup, comprising:
a support assembly;
an outer shell wrapped around an outer side of the support assembly, wherein the outer shell adopts a soft rubber material;
a transmission assembly movably arranged in the support assembly;
a double-headed massage cylinder being a hollow cavity with two ends open, wherein the double-headed massage cylinder is arranged in the outer shell and integrally formed with the outer shell, the double-headed massage cylinder movably passes through the support assembly and is in transmission connection with the transmission assembly, and the transmission assembly drives the double-headed massage cylinder to make a transverse stretching movement in the support assembly.

2. The double-headed stretched masturbation cup according to claim 1, wherein the support assembly comprises a first shell and a second shell which form a hollow cavity in a surrounding manner, and the transmission assembly is movably arranged in the cavity.

3. The double-headed stretched masturbation cup according to claim 2, wherein a plurality of first fixing columns are arranged on an inner wall of the first shell; a plurality of second fixing columns are arranged on an inner wall of the second shell, and positions of the plurality of second fixing columns respectively correspond to positions of the plurality of first fixing columns.

4. The double-headed stretched masturbation cup according to claim 2, wherein a plurality of mounting columns are arranged on an inner wall of the first shell, and the transmission assembly and the circuit board are fixedly arranged in the first shell respectively through the corresponding mounting columns.

5. The double-headed stretched masturbation cup according to claim 4, wherein a plurality of fixing holes are arranged on a side wall of the first shell in a penetrating manner, and the transmission assembly is movably arranged in the support assembly through the plurality of fixing holes.

6. The double-headed stretched masturbation cup according to claim 5, wherein the transmission assembly comprises a plurality of guide rods, wherein the plurality of guide rods are respectively fixed through the corresponding fixing holes and are arranged in parallel on two opposite sides of the support assembly; a support mechanism, wherein the support mechanism is movably arranged on the plurality of guide rods and is in transmission connection with the double-headed massage cylinder; a driving mechanism fixedly arranged in the support assembly through the corresponding mounting columns; and a swing arm with two ends respectively in transmission connection with the driving mechanism and the support mechanism, wherein the driving mechanism drives, through the swing arm, the support mechanism to move on the plurality of guide rods.

7. The double-headed stretched masturbation cup according to claim 6, wherein the support mechanism comprises a first support frame and a second support frame which form a hollow cavity in a surrounding manner; a transmission head is arranged on the first support frame, and one end of the swing arm is in transmission connection with the transmission head.

8. The double-headed stretched masturbation cup according to claim 6, wherein the driving mechanism comprises a fixing cavity fixedly arranged in the support assembly through the corresponding mounting columns; a driving motor arranged in the fixing cavity and in transmission connection with the swing arm, wherein the driving motor is capable of rotating forward and reversely.

9. The double-headed stretched masturbation cup according to claim 1, wherein the outer shell adopts a soft rubber material, a first end face and a second end face are respectively arranged on two opposite sides of the outer shell, and shapes of the first end face and the second end face respectively adopt shapes of a female face and a female genitalia.

10. The double-headed stretched masturbation cup according to claim 9, wherein the first end face and the second end face are respectively provided with a second through-hole and a third through-hole in a penetrating manner, and the second through-hole and the third through-hole are arranged in a manner of respectively communicating with the double-headed massage cylinder.

11. The double-headed stretched masturbation cup according to claim 10, wherein the double-headed massage cylinder is a cylindrical hollow cavity with two ends open, a first connection end and a second connection end are respectively arranged on two opposite sides of the double-headed massage cylinder, wherein the first connection end is arranged in a manner of communicating with the second through-hole, and the second connection end is arranged in a manner of communicating with the third through-hole.

12. The double-headed stretched masturbation cup according to claim 1, wherein two ends of the double-headed massage cylinder are arranged in a communicating manner.

13. The double-headed stretched masturbation cup according to claim 1, wherein two ends of the massage body are arranged in a manner of not communicating with each other.

14. The double-headed stretched masturbation cup according to claim 1, wherein a plurality of massage parts are evenly and separately arranged on an inner wall of the double-headed massage cylinder.

15. The double-headed stretched masturbation cup according to claim 14, wherein the massage parts adopt protruding points, and the protruding points and the double-headed massage cylinder are integrally formed.

16. The double-headed stretched masturbation cup according to claim 1, further comprising a circuit board, a battery assembly, a key assembly and a charging assembly; the circuit board and the battery assembly being respectively fixedly arranged in the support assembly, and the circuit board being respectively electrically connected to the transmission assembly, the battery assembly, the key assembly and the charging assembly; the key assembly and the charging assembly being respectively arranged on the circuit board and respectively passing through the support assembly.

17. The double-headed stretched masturbation cup according to claim 16, wherein a wireless communication module is arranged on the circuit board, and the wireless communication module adopts one or more of a Bluetooth wireless communication module, a WiFi wireless communication module, a 4G wireless communication module, and a 5G wireless communication module.

18. The double-headed stretched masturbation cup according to claim 16, wherein the battery assembly adopts a polymer lithium-ion battery.

19. The double-headed stretched masturbation cup according to claim 16, wherein the key assembly comprises a switch key and a function key, the switch key controls opening and closing of a masturbation cup, and the function key performs function setting on the masturbation cup.

20. The double-headed stretched masturbation cup according to claim 16, wherein the charging assembly adopts one or more of a charging needle, a Type C charging interface, a Micro USB charging interface, and a Lightning charging interface.
